(19) United States
(12) Patent Application Publication
(10) Pub. No.: US 2005/0209859 A1
(43) Pub. Date: Sep. 22, 2005

(54) Method for aiding and enhancing verbal communication

(75) Inventors: Samuel Sergio Tenembaum, Punta Del Este (UY); Moises Swiczar, Buenos Aires (AR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Porto Ranelli, SA, Punta Del Este (UY)

(21) Appl. No.: 11/041,001

(22) Filed: Jan. 21, 2005

Related U.S. Application Data
(60) Provisional application No. 60/538,739, filed on Jan. 22, 2004.

(51) Int. Cl. G10L 11/00

(52) U.S. Cl. 704/277

(57) ABSTRACT

A method of facilitating oral communication between two or more participants involves monitoring the oral communications with a voice recognition program so as to convert the sound bytes of the conversation into a textual record of the oral communications. Then the textual records are then presented on a display in real time with the communication. If desired, the textual records can also be translated into another language by a translation program in real time with the communication so as to improve the understanding of each party.

### CLAIM OF PRIORITY

This application claims the benefit of priority under 35 U.S.C. § 119(e) to U.S. Provisional Application No. 60/538,739, filed Jan. 23, 2004, titled “Method for Aiding and Enhancing Verbal Communication ,” hereby incorporated by reference in its entirety.

### FIELD OF THE INVENTION

The present invention relates generally to a method for aiding and enhancing verbal communications between people using computing devices connected to a network by providing software versions of the verbal communications that can be indexed, logged, sorted, translated and otherwise processed like a document.

### BACKGROUND OF THE INVENTION

The advent of the Internet has resulted in exponentially increased commerce and communications between remote parties. Current technology enables people and companies to do business across the world, creating a myriad of cultural and communicational challenges, such as language differences.

These parties interact on a daily basis in a number of ways, including telephone calls, faxes, e-mails, videoconferences and file transfers. The more remote the transactions and exchanges that occur, the more likely it is that verbal communications will not suffice. Yet, it is the most natural and convenient way to exchange information, and the oldest, after gestures and physical contact.

Even though voice recognition software is widely used in telecommunications, until the present invention it was used only to replace customer service agents, either in simple queries (e.g. finding a sport or movie schedule) or as a way to direct and hold callers until a representative becomes available (e.g. telephone and credit card companies). These applications are possible owing to the limited number of questions and answers that occur in those contexts. The current limitations of voice recognition software and it's need for “training” for each user is overridden by the fact that there are a finite number of possible outcomes; such as the number of flights departing on a given day, or the days of the week, or what movies are playing at a given cinema. The present invention uses voice recognition software, such as Via Voice manufactured by IBM or Naturally Speaking manufactured by Dragon Systems, to aid the communication between parties, not to replace one of them.

The invention turns conversations into HTML and XML documents that can be indexed and logged in real time for automatic subtitling using voice recognition programs; translating; archival and sorting of conversations. In addition, the invention may be used to provide contextual information to speakers in real time, providing them with data that is relevant to the current conversation.

The present invention can also be used to generate a manageable paper trail of verbal communications, like telephone conversations, since audio only files cannot be searched and tracked efficiently.

The way the present invention works is by using voice recognition software to generate text records of conversations in HTML or XML formats, and using these records: displaying them on the screen in real time, archiving a composite of the sound bits and the captions, establishing synchronicity between the two for later access and accessing databases for aggregation of data.

### SUMMARY OF THE INVENTION

The present invention relates to facilitating oral communications between parties. In accordance with one aspect of the invention, sound bytes of an oral communication are converted into a textual record. Such a record is displayed to one or more participants of the oral communication. In accordance with another aspect of the invention, the textual records are indexed and logged in real time, and subtitles are automatically displayed using voice recognition software.

In accordance with a further aspect of the invention, accuracy of the voice-to-text conversions is enhanced by simultaneously using multiple voice recognition programs to convert or the oral communications to multiple textual documents, and to compare the results.

These and other aspects, features, steps and advantages can be further appreciated from the accompanying figures and description of certain illustrative embodiments

### BRIEF DESCRIPTION OF THE DRAWING FIGURES

The foregoing brief description, as well as further objects, features, and advantages of the present invention will be understood more completely from the following detailed description of a presently preferred, but nonetheless illustrative embodiment, with reference being had to the accompanying drawing, in which

FIG. 1 is an illustration of a system layout for practicing the present invention; and

FIG. 2 is a flow chart of the process of the present invention.

### DETAILED DESCRIPTION OF THE ILLUSTRATIVE EMBODIMENTS

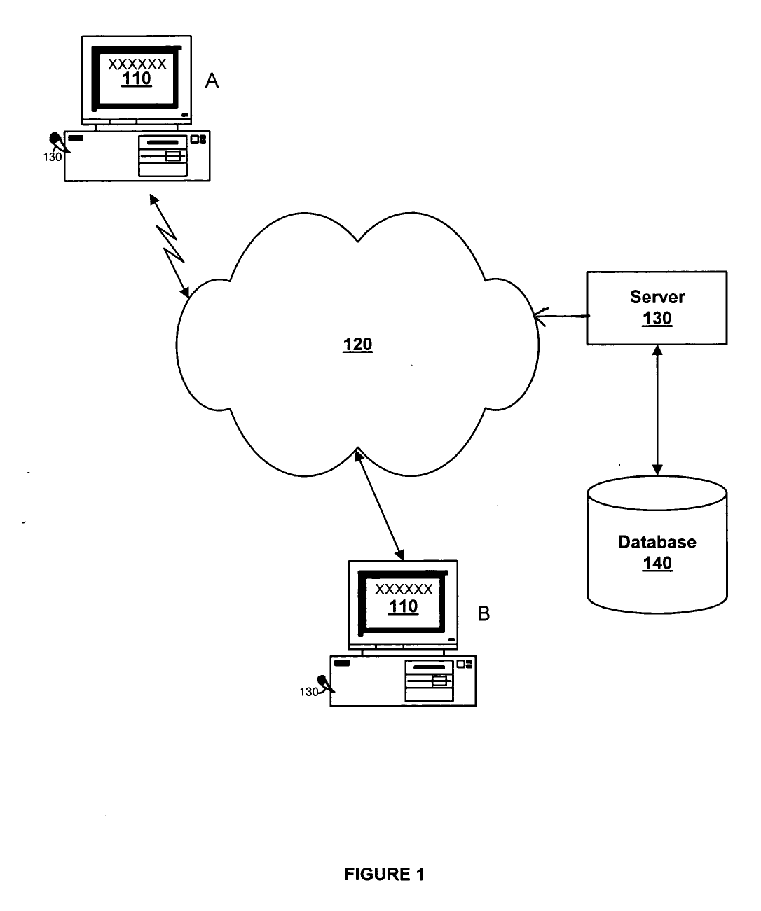

In an embodiment of the invention, a combination of computing devices and Internet and telephone technology is used to allow verbal communication capable of being recorded. Referring to FIG. 1, this embodiment includes a couple of computers 110 connected to a communication network, e.g., the Internet 120 in order to communicate with each other and or to access a host server 130 at some remote location. The computers 110 may for example include audio capability, e.g., loud speakers and microphones 130.

Each of the computers is equipped with voice recognition software, and may also preferably be equipped with computer language translation programs. If one user A is in communication with another B, and are speaking to each other, e.g. using voice over internet with microphones 130 and the speakers, the present invention enhances this communication by converting the oral sounds into text XXXX and displaying it on the displays 140 of the computers of users A and B. Thus, if one of the user's speech is not clear, the other user can still understand it by reading the text on display 140. Further, if one of the users is speaking in English and the other is speaking in a foreign language, the translation program can use text and convert it in real time to the language of the other user.

The present application describes a preferred embodiment of the current invention. The currently preferred embodiment uses two or more off-the-shelf voice recognition programs to turn spoken words into text and compares the results. If the results are exactly equal, then the text is presented to the user on the screen of his computing device (computer, phone, PDA, etc. . .). If the outcome of the voice recognition process is not equal on all programs, users are presented with all options and given the choice to select one. Alternatively, accuracy, defined as the match between programs or defined by each program, can be indicated by text size, boldness and/or color, among other visual cues. Those skilled in the art will appreciate that, if an odd number of voice recognition programs are used and a “vote” is taken between them, the need for an exact match can be avoided, as well as the deadlock that occurs when two devices disagree.

Through-out the process, key frames can be set on the audio portion and matched to each word of the resulting text, which makes later access to the information much more convenient and efficient. Communications may be represented in segments, where each segment represents a key frame, which can be isolated from the rest. The key frames are labeled and can identify the location of each word in a frame.

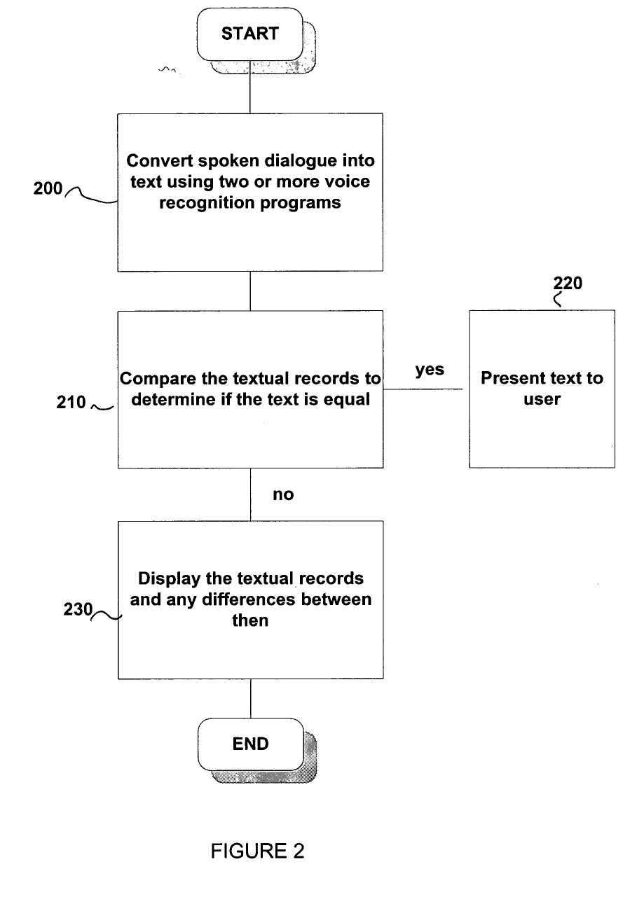

As shown in FIG. 2, the present invention utilizes multiple programs for turning spoken dialogue into text, step 200. Then the results are compared in step 210. In case of a perfect match (or a majority vote), generated text is displayed on a screen for either or both parties to see, step 220. If the various programs do not agree on the output text (or a conclusive vote cannot be obtained), then various possibilities are offered to the speakers, so they can select the correct one, step 230. In time, the system learns to prioritize one recognition program over another (or among more than two programs) for each registered user. By tracking and recording each correction the system learns to recognize which voice recognition program works best with which sound. Instead of processing sound files in real time, the invention may even batch process the sound files off-line and then reach users for corrections. To further aid the accuracy of the voice-to-text process, the currently preferred embodiment of the invention records the voice of each speaker in a separate audio channel, which makes possible the use of different voice recognition solutions for each one of them.

Following are a few uses for the present invention.

Real-time captioning of conversations: One use of the present invention is to simply caption voice and video conferences in real time, which is useful not only for people with hearing disabilities, but also to aid in the intelligibility of the spoken word when parties are not native speakers or have speech impediments, even when a user is in a noisy environment or when using voice-over-IP (VOIP), which may hinder the quality of the sound.

Real-time translation of conversations:

A variation of the above use would incorporate a translation engine (or many, and compare their output in a similar way to the voice recognition software), hence allowing for conversations between parties who do not share a common language.

Archiving of conversations:

Another possible use for the invention is to archive conversations in a way that can be searched and categorized, which is not possible with sound files. Keeping an aural register of the conversation, as well as a textual one, and enabling the synchronization of both allows the system to provide search and categorization capability for the audio files. It now becomes possible to search the entire conversation as with any text file, and to check the accuracy of any portion by listening to the original audio record. This method can also be used for enhanced access to radio, film and TV content: e.g., the user could navigate a DVD by searching its dialogue.

Real time contextual information:

The current invention can also be used to provide users with information that is relevant to the conversation in progress. For example, when a person's name is spoken, his or her personal information can be displayed on the fly, like his or her spouse's name, or a photograph. This is clearly of use to people dealing with many other people, and especially to the handicapped.

In addition to the above-described use, the present invention can be used to deliver email transcripts of phone conversations.

All of the services and applications herein described may be paid for by users or by sponsors, in exchange for advertising opportunities; like presenting users with commercials (in any format) that are relevant to the topic being discussed.

In addition to the preferred and described embodiment, those skilled in the arts will easily recognize other ways of achieving similar results using various programming languages and hybrid methods using software and human input. As an example of the later, after a recording of a conversation is emailed to a “verbal communications enhancement centre”, a human being can compare, correct and edit the results of automatic voice recognition and send it back to the original client for archival, search, or other use.

1. A method of facilitating oral communication between two or more participants, comprising the steps of:
monitoring said oral communications using with a voice recognition program so as to convert;
converting sound bytes into a textual record of the oral communicationsusing a voice recognition program;
generating a textual record of the oral communications; and
displaying the textual records on a computing deviceof the oral communications of the one or more participants of the oral communication.

2. The method of claim 1, further comprising the step of converting the oral communications textual record into HTML and XML documents.

3. The method of claim 1, further comprising the step of converting the oral communications textual record into one of either HTML or XML documents.

4. The method of claim 1, further comprising the step of establishing real time captioning of the oral communications.

5. The method of claim 1, further comprising the step of:
providing an index of the textual records in real time;
logging in the textual records in real time; and establishing automatic subtitling displaying on a computing device.

6. The method of claim 1, further comprising the step of:
creating an audio record of the oral communication;
storing the audio record of the oral communication and the textual record in an archive;
establishing synchronicity between the audio record of the oral communication and the textual record to enable future access; and
providing searching and tracking capabilities of the stored synchronized records through the textual record.

7. The method of claim 6, further comprising the step of searching using the textual record as a navigational tool for searching the audio record.

8. The method of claim 1, further comprising the step of using one or more additional softwaretranslation programs to provide and display a translation of the textual record in real time in a language other than the one in which the communication took place.

9. The method of claim 1, further comprising the step of:
pre-identifying the audio of possible words appearing in the oral communication;
associating relevant textual information to each pre-identified word
providing the associated relevant information when the pre-identified word appears in the oral communication; and
displaying the associated relevant information on a computing device.

10. The method of claim 1, further comprising the step of using content and meaning in oral communications to target advertising.

11. The method of claim 1, wherein the communication between the participants is over a path and the path is at least one of an internet connection, a telephone connection, a video telephone connection, and a voice over internet protocol connection.

12. A method as claimed in claim 1 further including the steps of:
using two or more voice recognition programs simultaneously to monitor oral communications and to convert simultaneously the;
performing at least two conversions of oral communications to two or more textual records simultaneously;
assessing the accuracy of the conversion process by comparing the two or more textual records to assess the accuracy of the conversion processesoutcome of each voice recognition program with one or more additional voice recognition programs; and
displaying the textual records and any difference between the two or more textual records.

13. A method of aiding the accuracy of a voice-to-text conversion process, comprising the steps of:
using two or more voice recognition programs simultaneously to monitor oral communications and to convert simultaneously the;
performing at least two conversions of oral communications to two or more textual records simultaneously;
assessing the accuracy of the conversion process by comparing the two or more textual records to assess the accuracy of the conversion processesoutcome of each voice recognition program with one or more additional voice recognition programs; and
displaying the textual records and any difference between the two or more textual records.

14. The method of claim 12, further comprising the steps of:
determining that the textual outcome of the conversion process is identical on all programs; and
displaying the textual outcome of the conversion to at least one participant on a computing device.

15. The method of claim 13, further comprising the steps of:
determining that variations exist in the textual outcome of the conversions of two or more voice recognition programs;
displaying all variations of the textual outcome to at least one participant; and
allowing at least one participant to select a preferred version of the text by indicating a preference for one of the differences between the two or more textual records.

16. The method of claim 13, wherein there are at least three voice recognition programs providing at least three textual records and further comprising the steps of:
determining that variations exist in the textual outcome of the conversions of two or more voice recognition programs;
defining a voting criteria for selecting the most accurate version of the conversions performed by automatically selecting the textual difference provided by the majority of the voice recognition programs; and
performing the vote between the voice recognition program conversions;
displaying the most accurate textual outcome of a conversion to at least one of the participants.
